(19) United States
(12) Patent Application Publication
(10) Pub. No.: US 2005/0249056 A1
(43) Pub. Date: Nov. 10, 2005

(54) Vibration absorber system for an optical recording/reproducing apparatus

(75) Inventors: Chun-Chieh Wang, Tu-Chen (TW); Hung Chieh Tsai, Tu-chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 10/997,574

(22) Filed: Nov. 24, 2004

(30) Foreign Application Priority Data
May 7, 2004 (CN) 200420045688.7

(51) Int. Cl. G11B 7/00

(52) U.S. Cl. 369/44.14; 369/44.32; 369/53.18

(57) ABSTRACT

A vibration absorber system is attached to one side of a chassis of a traverse module of an optical recording/reproducing apparatus. The vibration absorber system includes a vibration absorber for soaking up vibration generated in the optical recording/reproducing apparatus, and at least two elastic dampers for elastically attaching the vibration absorber to the traverse module. Thus, internal vibration is soaked up by the vibration absorber system. Further, the vibration absorber system may be attached to a lighter side of the chassis. Thus, imbalance of the traverse module is reduced or eliminated by the vibration absorber system.

### BACKGROUND OF THE INVENTION

1. Field of the Invention

The present invention generally relates to a vibration absorber system for an optical recording/reproducing apparatus, and more particularly to a vibration absorber system for an optical recording/reproducing apparatus which can effectively dampen vibration in the optical recording/reproducing apparatus and reduce or eliminate imbalance of a traverse module of the optical recording/reproducing apparatus.

2. Description of the Prior Art

Recently, the speed of optical recording/reproducing apparatuses such as CD-Players and DVD-Players has been much improved, with speeds of 24x, 48x and even 52x being attained. A key reason for achieving much higher operation speeds has been the ability to limit the vibration generated by a rotating spindle motor or a feeding pickup unit of the optical recording/reproducing apparatus. A few major solutions are popular regarding vibration damping systems of conventional optical recording/reproducing apparatuses, as detailed below.

One solution is an automatic balance system (ABS). The automatic balance system is coupled to a rotating body of an optical recording/reproducing apparatus such as a spindle motor, to reduce internal vibrations generated due to eccentric mass of an optical disc. A plurality of moving members is movably disposed in a circular race concentrically formed in the spindle motor. The moving members stay in the race at positions whereby the spindle motor is at a balanced position. However, this solution is only effective when the spindle motor is rotating at high speed. When the spindle motor starts up or brakes, the moving members run irregularly in the race and impact one another. This is liable to generate excessive vibration and noise.

Another solution is an application of Newton's second law. The law is expressed by the equation: F=ma (F=force; m=mass; a=acceleration). This equation expresses that for a constant force acting on an object, the greater the mass of the object, the smaller its acceleration will be. Based on this theory, a conventional optical recording/reproducing apparatus is built with a heavy chassis. This reduces the acceleration of the chassis, and thereby reduces the vibration of the optical recording/reproducing apparatus. However, this solution has limited effectiveness and is seldom used.

A further solution is a vibration absorber system (VAS). A typical vibration absorber system is shown in FIG. 4. A vibration absorber 3 with a similar shape to a base 2 is elastically supported on the base 2 via three dampers 3a. Vibration generated by a spindle motor 4 or a pickup head 5 and its feeding mechanism 6 is isolated from a frame (not shown) by several isolators 2a, and is absorbed by the vibration absorber 3 via the dampers 3a.

The above-described vibration absorber system has the vibration absorber 3 which effectively takes up internal vibration via the dampers 3a, and simultaneously the isolators 2a isolate external vibration. However, the vibration absorber 3 is unduly complicated and costly to manufacture and assemble. In addition, the feeding mechanism 6 is located at one lateral side of the base 2, while the other opposite lateral side of the base 2 has no apparatus or component mounted thereon. Therefore, the base 2 is liable to tilt because of imbalance.

### SUMMARY OF THE INVENTION

Accordingly, an object of the present invention is to provide a simple vibration absorber system for an optical recording/reproducing apparatus which effectively eliminates internal vibration.

Another object of the present invention is to provide a vibration absorber system for an optical recording/reproducing apparatus which can reduce or eliminate imbalance of a traverse module.

In order to achieve the objects set out above, a vibration absorber system for an optical recording/reproducing apparatus of the present invention is attached to one side of a chassis of a traverse module of the optical recording/reproducing apparatus. The vibration absorber system comprises a vibration absorber for soaking up vibration generated in the optical recording/reproducing apparatus, and at least two elastic dampers for elastically attaching the vibration absorber to the traverse module. Therefore, internal vibration is soaked up by the vibration absorber system. Further, the vibration absorber system may be attached to a lighter side of the chassis. Thus, imbalance of the traverse module is reduced or eliminated by the vibration absorber system.

### BRIEF DESCRIPTION OF THE DRAWINGS

Other objects, advantages and novel features of the present invention will become more apparent from the following detailed description when taken in conjunction with the accompanying drawings, in which:

FIG. 1 is an exploded, isometric view of a vibration absorber system in accordance with the present invention ready to be mounted on a frame of an optical disc drive;

FIG. 2 is an assembled view of FIG. 1;

FIG. 3 is a cross-sectional view taken along line III-III of FIG. 2; and

FIG. 4 is an isometric view of a conventional vibration absorber system for an optical disc drive.

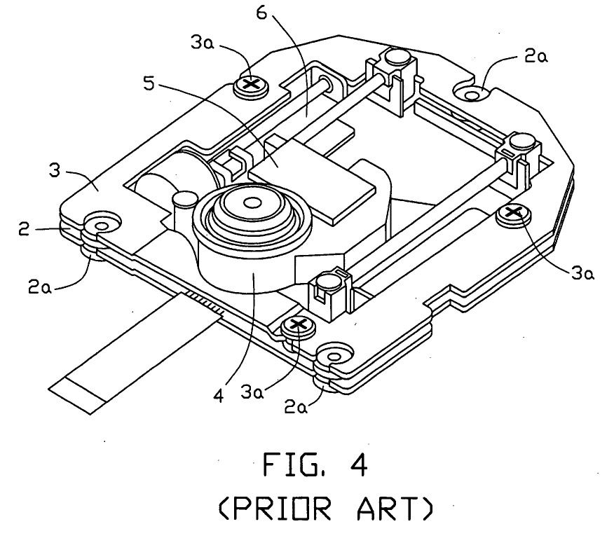

### DETAILED DESCRIPTION OF THE INVENTION

Reference will now be made to the drawing figures to describe the preferred embodiment of the present invention in detail.

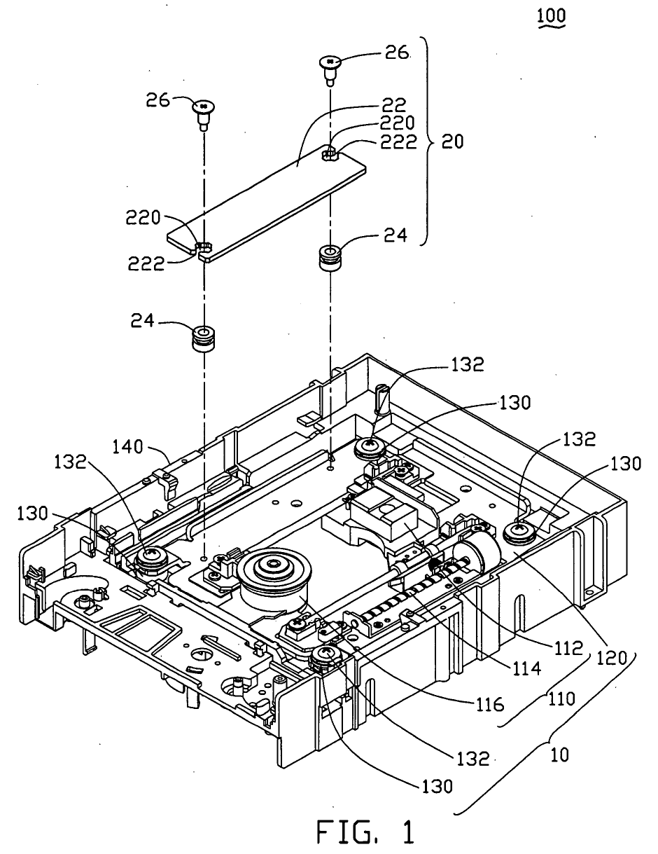

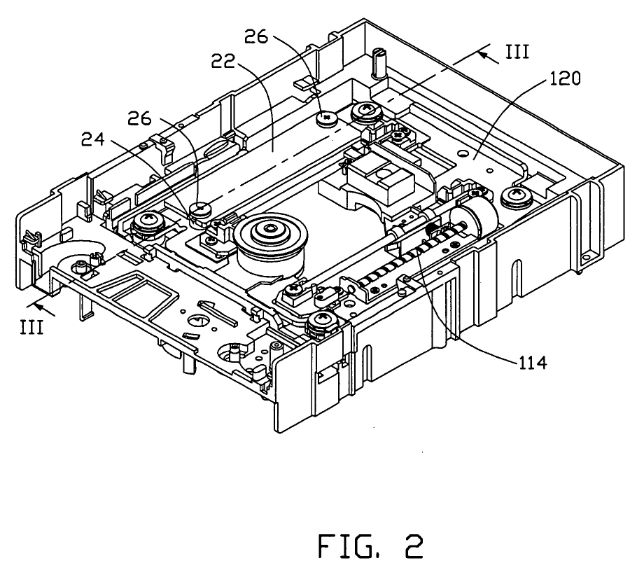

As shown in FIGS. 1 and 2, a traverse module 10 is mounted on a frame 140 via four elastic isolators 130 and four corresponding screws 132. The traverse module 10 comprises a driving unit 110 fixed on a rectangular chassis 120. The driving unit 110 comprises a pickup head 112 for recording/reproducing information to/from a disc, a feeding mechanism 114 for driving the pickup head 112, and a spindle motor 116 for rotating the disc. The pickup head 112 is slidable within a rectangular opening of the chassis 120, and is guided by a pair of parallel guiding rods (not labeled). The spindle motor 116 is mounted on a middle portion of a front end of the chassis 120. The feeding mechanism 114 is mounted on a long lateral side portion of the chassis 120.

A vibration absorber module 20 is arranged on an opposite long lateral side portion of the chassis 120, symmetrically opposite to the feeding mechanism 114. The vibration absorber module 20 comprises a vibration absorber 22, a pair of elastic dampers 24, and a pair of corresponding screw bolts 26. The vibration absorber 22 is a rectangular plate. Two mounting holes 220 are defined in two diagonally opposite corners of the vibration absorber 22 respectively. Each mounting hole 220 has an opening 222 at a corresponding end edge of the vibration absorber 22. A midpoint between the mounting holes 220 coincides with a barycenter of the vibration absorber 22. The vibration absorber 22 is mounted on the chassis 120 via the dampers 24 and the screw bolts 26.

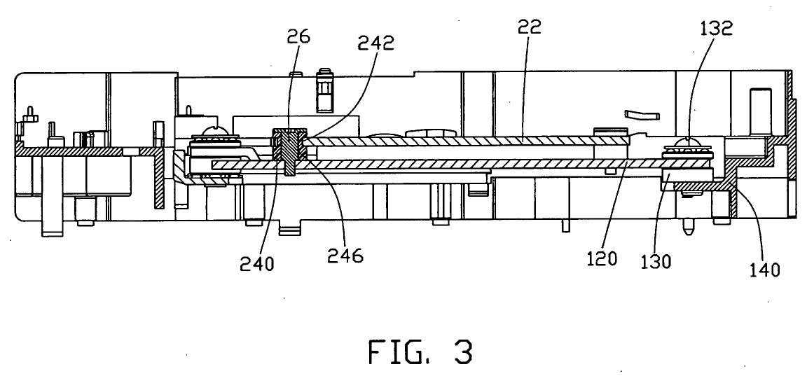

Now referring to FIG. 3, each damper 24 has a generally cylindrical body 240. An annular insertion groove 242 is defined in a circumferential periphery of the body 240. A through hole 246 is axially defined through a center of the body 240.

In assembly of the vibration absorber module 20, the dampers 24 at the insertion grooves 242 thereof are respectively inserted into the mounting holes 220 of the vibration absorber 22 via the openings 222. The screw bolts 26 are extended through the through holes 246 of the dampers 24, and are threadingly engaged in corresponding tap holes (not labeled) of the chassis 120. The vibration absorber module 20 is thus mounted on the chassis 120 of the traverse module 10.

After assembly, the traverse module 10 is a primary system isolated from external vibration. When external vibration is transmitted to the frame 140, the traverse module 10 is isolated by the elastic isolators 130 and remains static. The vibration absorber module 20 is a secondary system for soaking up internal vibration. When internal vibration is produced by the rotating spindle motor 116 or the operating feeding mechanism 114, the internal vibration is transmitted to the vibration absorber 22 via the elastic dampers 24.

In preferred embodiments, the traverse module 10 and the vibration absorber module 20 have the same vibrational frequency, so that the internal vibration of the traverse module 10 is efficiently soaked up by the vibration absorber module 20. Thus, the following equation is derived:
f₁=f₂ [1]
where:
f₁ is the vibratory frequency of the traverse module 10; and
f₂ is the natural frequency vibration of the absorber module 20. It is known that

$$f = \sqrt{\frac{k}{m}} ,$$

therefore the following equation is derived:

$${f}_{2} = \sqrt{\frac{{k}_{2}}{{m}_{2}}} \qquad [ 2 ]$$
where:
   m₂ is the mass of the vibration absorber module 20; and
   k₂ is the elastic coefficient of the vibration absorber module 20.

Accordingly, the mass m2 and the elastic coefficient k2 of the vibration absorber module 20 should be properly chosen in order to satisfy equation [1].

Because the vibration absorber module 20 is set on the chassis 120 symmetrically opposite to the feeding mechanism 114, imbalance caused by the feeding mechanism 114 is reduced or eliminated, and a turntable (not labeled) of the spindle motor 116 can remain horizontal.

In alternative embodiments, the vibration absorber module 20 may be mounted under the chassis 120, opposite to the feeding mechanism 114. Further, the vibration absorber 22 may have a shape other than rectangular, as long as the natural frequency vibration of the absorber module 20 is equal to the vibratory frequency of the traverse module 10.

Although the present invention has been described with reference to specific embodiments, it should be noted that the described embodiments are not necessarily exclusive, and that various changes and modifications may be made to the described embodiments without departing from the scope of the invention as defined by the appended claims.

1. A vibration absorber system for an optical recording/reproducing apparatus having a traverse module, the vibration absorber system being adapted to be attached to one side of a chassis of the traverse module, the vibration absorber system comprising:
a vibration absorber for soaking up vibration generated in the optical recording/reproducing apparatus; and
at least two elastic dampers for elastically attaching the vibration absorber to the traverse module.

2. The vibration absorber system as recited in claim 1, wherein a natural frequency of the vibration absorber is equal to a vibratory frequency of the traverse module.

3. The vibration absorber system as recited in claim 2, wherein the vibration absorber is a rectangular plate.

4. The vibration absorber system as recited in claim 3, wherein the vibration absorber defines at least two mounting holes, the at least two mounting holes engagingly receiving the at least two elastic dampers.

5. The vibration absorber system as recited in claim 4, wherein each of the dampers defines an insertion groove therein.

6. The vibration absorber system as recited in claim 5, wherein the at least two dampers are engaged in the corresponding mounting holes of the vibration absorber at the insertion grooves.

7. The vibration absorber system as recited in claim 6, wherein the vibration absorber system is adapted to be mounted at a top side of the chassis.

8. The vibration absorber system as recited in claim 6, wherein the vibration absorber system is adapted to be mounted at an underside of the chassis.

9. The vibration absorber system as recited in claim 1, wherein the vibration absorber system is adapted to be mounted to a lighter side of the chassis, for reducing or eliminating imbalance of the traverse module.

10. The vibration absorber system as recited in claim 9, wherein the vibration absorber is a rectangular plate.

11. An optical recording/reproducing apparatus, comprising:
a frame;
a traverse module including a chassis; and
a vibration absorber system including a vibration absorber for soaking up vibration, and at least two elastic dampers elastically supporting the vibration absorber;
wherein the vibration absorber module is attached to a side of the chassis of the traverse module.

12. The optical recording/reproducing apparatus as recited in claim 11, wherein a natural frequency of the vibration absorber is equal to a vibratory frequency of the traverse module.

13. The optical recording/reproducing apparatus as recited in claim 12, wherein the vibration absorber is a rectangular plate.

14. The optical recording/reproducing apparatus as recited in claim 13, wherein the vibration absorber system is mounted on a top side of the chassis.

15. The optical recording/reproducing apparatus as recited in claim 13, wherein the vibration absorber system is mounted on an underside of the chassis.

16. The optical recording/reproducing apparatus as recited in claim 11, wherein the vibration absorber system is mounted to a lighter side of the chassis, for reducing or eliminating imbalance of the traverse module.

17. The optical recording/reproducing apparatus as recited in claim 16, wherein the vibration absorber is a rectangular plate.

18. The optical recording/reproducing apparatus as recited in claim 17, wherein the vibration absorber system is mounted to an underside of the chassis.

19. A vibration absorber system for an optical recording/reproducing apparatus having a traverse module, the vibration absorber system only attached to one side of a chassis of the traverse module, the vibration absorber system comprising:
a vibration absorber for soaking up vibration generated in the optical recording/reproducing apparatus; and
means for elastically attaching the vibration absorber to the traverse module.
